(19) United States
(12) Patent Application Publication
(10) Pub. No.: US 2009/0263605 A1
(43) Pub. Date: Oct. 22, 2009

(54) SURFACE-HYDROPHILIC STRUCTURE

(76) Inventors: Satoshi Hoshi, Tokyo (JP); Toshiaki Aoai, Kanagawa (JP); Kazuto Kunita, Shizuoka (JP); Satoshi Tanaka, Kanagawa (JP); Kazuto Shimada, Shizuoka (JP)

Correspondence Address: BIRCH STEWART KOLASCH & BIRCH, PO BOX 747, FALLS CHURCH, VA, 22040-0747, US

(21) Appl. No.: 12/067,495

(22) PCT Filed: Nov. 16, 2006
(86) PCT No.: PCT/JP2006/323374

§ 371 Date: Mar. 20, 2008

(30) Foreign Application Priority Data
Nov. 16, 2005 (JP) 2005-331654
Nov. 16, 2005 (JP) 2005-331655

(51) Int. Cl. B32B 33/00; B32B 17/06; B05D 3/02

(52) U.S. Cl. 428/40.4; 428/447; 428/688; 428/689; 428/341; 428/426; 427/385.5; 427/387

(57) ABSTRACT

A structure comprising: an adhesive layer; a plastic substrate; and a hydrophilic coating film, provided in this order, wherein the hydrophilic coating film includes a cross-linked structure produced by hydrolysis and polycondensation with an aqueous solution containing (a) a hydrophilic polymer and (b) an alkoxide of a metal selected from the group consisting of Si, Ti, Zr, and Al.

### TECHNICAL FIELD

This invention relates to a surface-hydrophilic member. More particularly, it relates to a surface-hydrophilic structure equipped with hydrophilic surface layer which exhibits superiority in hydrophilic property, durability, transparency, and storage stability.

### BACKGROUND ART

A resin film is used for various objects but it generally has a hydrophobic surface. Even an inorganic material, such as glass and metals, cannot be seen as sufficient in hydrophilic property. When a surface of a substrate is hydrophilized by using the resin film, the inorganic material, and the like, adhered water droplets are spread evenly on the surface of the substrate and form a uniform water film. Therefore, it is possible to protect effectively the fogging on glass, lenses, and mirrors, and is helpful for protecting devitrification caused by moisture and for ensuring visibility in the rain. Moreover, it is useful for various applications because the adhesion of hydrophobic contaminants such as urban dust, combustion products (e.g., carbon black contained in exhaust gases from automobiles), fats and oil, and substances released from some sealant materials to the surface of the substrate is hardly happened, and even the hydrophobic contaminants are adhered thereto, those contaminants are easily dropped by exposing to rain or water washing.

Conventionally proposed hydrophilizing surface treatments, such as an etching treatment and a plasma treatment, achieve a high hydrophilization degree, but the effect is temporary, and the hydrophilized state does not last long. A surface-hydrophilic coat using a hydrophilic graft polymer as one of the hydrophilic resins was also proposed (Jan. 30, 1995 article of The Chemical Daily). According to the report, the coat exhibits hydrophilicity to some extent but cannot be seen as having sufficient affinity to a substrate, still requiring improvement in durability.

Other known films having an excellent surface hydrophilic property include those utilizing titanium oxide. For instance, WO96/29375 discloses a hydrophilizing method in which a photo-catalyst layer is formed on a surface of a substrate and photo-excited to make the surface of the substrate highly hydrophilic. WO96/29375 says that the method is applicable to composite materials such as glass, lenses, mirrors, exterior materials, water-related products, and so forth to provide the composite materials with high resistance to fogging and staining. However, the hydrophilic film using titanium oxide does not have sufficient film strength, and a hydrophilic material with superior wear resistance has been required.

### DISCLOSURE OF THE INVENTION

An object of the present invention is to provide a surface-hydrophilic structure composed of a hydrophilic surface layer excellent in surface hydrophilicity, wear resistance, transparency, and storage stability.

With the above objects in mind, the present inventors have conducted researches with a particular note on the characteristics of hydrophilic graft polymers. As a result, they have found that the objects are accomplished by a surface layer having a hydrophilic polymer and a cross-linked structure formed by hydrolysis and polycondensation of a metal alkoxide; that such a cross-linked structure-containing surface layer is easily obtained by combining a hydrophilic polymer having reactive groups on a terminal or a hydrophilic polymer having graft chain with a crosslinking agent. The present invention is as follows.

(1) A structure comprising: an adhesive layer; a plastic substrate; and a hydrophilic coating film, provided in this order, wherein the hydrophilic coating film includes a cross-linked structure produced by hydrolysis and polycondensation with an aqueous solution containing (a) a hydrophilic polymer and (b) an alkoxide of a metal selected from the group consisting of Si, Ti, Zr, and Al.

(2) The structure according to (1), wherein the structure further comprises a glass layer so that the glass layer, the adhesive layer, the plastic substrate, and the hydrophilic coating film are provided in this order.

(3) The structure according to (1), wherein the structure has an exfoliatable (peelable) release layer arranged with in order of a release layer, an adhesive layer, a plastic substrate, and a hydrophilic coating film.

(4) The structure according to any one of (1) to (3), wherein the aqueous solution further contains a catalyst capable of forming a bond with (a) the hydrophilic polymer (the catalyst is preferably a metal complex catalyst, and more preferably, the metal complex catalyst is formed of a metal element selected from the group consisting of the groups 2A, 3B, 4A, and 5A of the Periodic Table and an oxo- or hydroxyl oxygen-containing compound selected from the group consisting of a β-diketone, a keto ester, a hydroxycarboxylic acid and an ester thereof, an amino alcohol, and an enol type active hydrogen compound.).

(5) The structure according to any one of (1) to (4), wherein the hydrophilic coating film additionally contains a colloidal silica.

(6) The structure according to any one of (1) to (5), wherein a surface of the plastic substrate is hydrophilized (subjected to hydrophilizing surface treatment) before the coating with the aqueous solution.

(7) The structure according to any one of (1) to (6), wherein (a) the hydrophilic polymer is represented by at least any one selected from formula (I) and formula (II) described below:

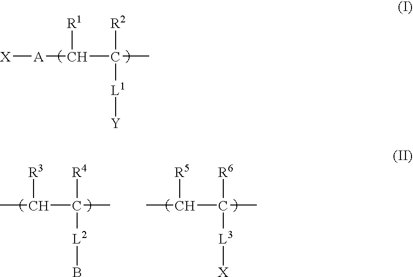

wherein R¹, R², R³, R⁴, R⁵, and R⁶ each independently represent a hydrogen atom or a hydrocarbon group having from 1 to 8 carbon atoms; X represents a reactive group (e.g., carboxyl group and salt thereof, carboxylic acid anhydride group, amino, hydroxyl, epoxy group, methylol, mercapto, isocyanato, block isocyanato group, alkoxysilyl group, alkoxy titanate group, an alkoxy aluminate group, an alkoxy zirconate group, an ethylenically unsaturated group, an ester group, and a tetrazole group); A, L¹, L² and L³ each independently represent a single bond or a linking group; Y represents —NHCOR⁷, —CONH₂, —CON(R⁷)₂, —COR⁷, —OH, —CO₂M, —SO₃M, —PO₃M, —OPO₃M or —N(R⁷)₃Z¹ (wherein R⁷ represents an alkyl group having from 1 to 18 carbon atoms, an aryl having from 1 to 18 carbon atoms or an aralkyl group having from 1 to 18 carbon atoms; M represents a hydrogen atom, an alkali metal, an alkaline earth metal or an onium group; and Z¹ represents a halide ion); and B represents a structure represented by the following formula (III):

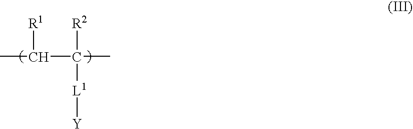

where R¹, R², L¹, and Y are as defined above.

(8) The structure according to any one of (1) to (7), wherein the hydrophilic coating film has a surface free energy in the range of 70 to 95 mN/m.

(9) The structure according to any one of (1) to (8)ᵣ wherein (a) the hydrophilic polymer has a hydrophilic group density in the range of 1 to 30 meq/g.

(10) The structure according to any one of (1) to (9), wherein (a) the hydrophilic polymer has a viscosity in the range of 0.1 to 100 cPs in a 5% aqueous solution.

(11) The structure according to any one of (1) to (10), wherein the hydrophilic coating film has a light transmittance in the range of 70 to 100%.

In the present invention, a hydrophilic polymer is involved in a cross-linked structure resulting from hydrolysis and polycondensation of a metal alkoxide. The hydrophilic polymer is chemically bonded to the cross-linked structure via its terminal or its main chain to which a hydrophilic polymer is grafted. Therefore, the hydrophilic polymer chain has very high mobility to provide a highly hydrophilic surface.

The cross-linked structure resulting from hydrolysis and polycondensation of the metal alkoxide is a cured film with a high crosslinking density, and forms a coating film with high strength and durability. Accordingly, a thin plastic substrate having a weak waist and a low cushion effect may be used, and the cross-linked structure can be applied to a nonplanar glass structure such as curved mirrors as well as a planar glass because it is hard to being cracked by bending or pressure injection.

The cross-linked structure resulting from hydrolysis and polycondensation of the metal alkoxide is a cured film with a high crosslinking density, and forms a coating film with high strength and durability. Accordingly, a hydrophilic layer on the plastic substrate can have a normal hydrophilic surface at any time without malfunction such as cracking caused by bending at the time of producing or pasting.

In the present invention, by using a certain catalyst, it is possible to set the drying temperature low to form a hydrophilic coating film and to inhibit a thermal distortion of the plastic substrate and a degeneration of adhesive layer caused by heat.

The hydrophilic coating film of the structure in the present invention has a very high surface hydrophilicity but the hydrophilic layer is hard to comprise water because a cured film with a high crosslinking density is obtained by hydrolysis and polycondensation of a metal alkoxide. For that reason, a stickiness caused by the environmental humidity (especially, under the condition of high humidity) is inhibited and a back side adhesion is protected when a structure is preserved layer upon layer. That is, when preserving the structure, inhibiting the malfunction such as the stripped by the hydrophilic surface and the back side adhesion of the structure lied thereon is possible.

### BEST MODE FOR CARRYING OUT THE INVENTION

Detailed description of the present invention is below. The structure of the present invention has a hydrophilic polymer chain and a hydrophilic coating film (hereinafter sometimes simply referred to as a hydrophilic layer) having a cross-linked structure resulting from hydrolysis and polycondensation of an alkoxide of a metal selected from Si, Ti, Zr, and Al on an appropriate substrate. A hydrophilic layer having such a cross-linked structure can conveniently be formed using a metal alkoxide (as described later) and a compound having a hydrophilic functional group capable of forming a hydrophilic graft chain. Of various metal alkoxide, preferred are silicon alkoxides in view of their reactivity and availability. Specific examples of the silicon alkoxides are the compounds used as silane coupling agents.

The aforementioned cross-linked structure formed by hydrolysis and polycondensation of a metal alkoxide may be called as a sol-gel cross-linked structure. Such a hydrophilic layer in which a polymer chain has large mobility with its one terminal non-fixed can easily be formed on a substrate by coating a substrate with a hydrophilic coating composition, followed by drying. The hydrophilic coating composition contains, for example, (A) a polymer of formula (I) having a reactive group (e.g., a silane coupling group) at its terminal or a polymer of formula (II) having such a reactive group in the side chain of a trunk polymer, and (B) a hydrolyzable metal alkoxide. In what follows, the components constituting the hydrophilic coating composition for forming the preferred hydrophilic layer will be described in detail.

[Hydrophilic Polymer]

The hydrophilic polymer used in the invention has a hydrophilic group and a group capable of forming a bond with a metal alkoxide of a metal selected from Si, Ti, Zr, and Al by the action of a catalyst. Preferred examples of the hydrophilic group include functional groups such as a carboxy group and an alkali metal salt thereof, a sulfonic acid group or an alkali metal salt thereof, a hydroxy group, an amide group, a carbamoyl group, a sulfonamide group, a sulfamoyl group, a phosphate group and an alkali metal salt thereof, an oxyphosphate group and alkali metal salt thereof. The hydrophilic group may be at any position in the polymer molecule. It is preferred that the polymer have a plurality of such hydrophilic groups each bonded to its main chain either directly or via a linking group or bonded to its side chain or the side chain of a graft. Examples of the group capable of forming a bond with a metal alkoxide by the action of a catalyst include reactive groups such as a carboxyl group, an alkali metal salt of a carboxy group, a carboxylic acid anhydride group, an amino group, a hydroxy group, an epoxy group, a methylol group, a mercapto group, an isocyanate group, a blocked isocyanate group, an alkoxysilyl group, an alkoxy titanate group, an alkoxy aluminate group, an alkoxy zirconate group, an ethylenically unsaturated group, an ester group, and a tetrazole group. The polymer having a hydrophilic group and a group capable of forming a bond with a metal alkoxide by the action of a catalyst preferably has a structure formed by vinyl polymerization of an ethylenically unsaturated group (e.g., an acrylate group, a methacrylate group, an itaconic acid group, a crotonic acid group, a cinnamic acid group, a styrene group, a vinyl group, an allyl group, a vinyl ether group or a vinyl ester group), a polycondensed structure as possessed by polyester, polyamide or polyamic acid, an additionally polymerized structure as possessed by polyurethane, or a naturally occurring cyclic polymer structure as observed with cellulose, amylose, chitosan, etc. Specific examples of the hydrophilic polymer include those represented by formula (I) and formula (II).

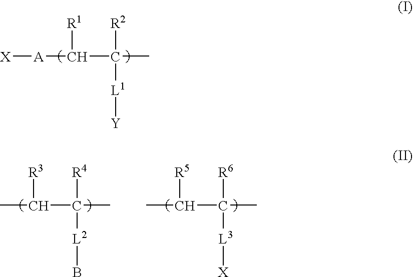

wherein R¹, R², R³, R⁴, R⁵, and R⁶ each independently represent a hydrogen atom or a hydrocarbon group having 1 to 8 carbon atoms; X represents a reactive group (e.g., a carboxyl group or an alkali metal salt thereof, a carboxylic acid anhydride group, an amino group, a hydroxyl group, an epoxy group, a methylol group, a mercapto group, an isocyanate group, a blocked isocyanate group, an alkoxysilyl group, an alkoxy titanate group, an alkoxy aluminate group, an alkoxy zirconate group, an ethylenically unsaturated double bond, an ester bond or a tetrazole group); A, L¹, L², and L³ each independently represent a single bond or a linking group; Y represents —NHCOR⁷, —CONH₂, —CON(R⁷)₂, —COR⁷, —OH, —CO₂M, —SO₃M, —PO₃M, OPO₃M or —N(R⁷)₃Z¹ (wherein R⁷ represents an alkyl, aryl or aralkyl group having 1 to 18 carbon atoms; M represents a hydrogen atom, an alkali metal, an alkaline earth metal or an onium group; and Z¹ represents a halide ion); and B represents a partial structure represented by formula (III):

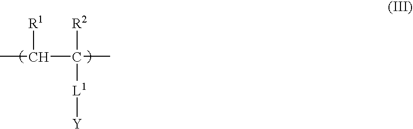

wherein R¹, R², L¹, and Y are as defined above.

The hydrophilic polymer than can be used in the invention has a reactive group and a hydrophilic group. The hydrophilic polymer may have a reactive group at one terminal of the main chain or at least two reactive groups bonded to the main chain.

The term “reactive group” as used herein denotes a functional group reactive with a hydrolysis/polycondensation product of a metal alkoxide to form a chemical bond. A plurality of such reactive groups may react with each other to form a chemical bond. The hydrophilic polymer is preferably water soluble. It is preferred for the hydrophilic polymer to become water insoluble on reacting with a hydrolysis/polycondensation product of the metal alkoxide.

The term “chemical bond” is intended to include a covalent bond, an ionic bond, a coordination bond, and a hydrogen bond as is commonly used. The chemical bond is preferably a covalent bond.

The “reactive group” is generally the same as the one contained in a polymer crosslinking agent that forms a crosslinked structure on heat or light application. For the details of the crosslinking agent, reference can be made to S. Yamashita and T. Kaneko, Kakyozai Handbook, Taiseisya (1981).

Examples of the reactive group include a carboxyl group (HOOC—) or a salt thereof (MOOC—, M is a cation), a carboxylic acid anhydride group (a monovalent group derived from, e.g., succinic anhydride, phthalic anhydride or maleic anhydride), an amino group (H₂N—), a hydroxyl group (HO—), an epoxy group (e.g., glycidyl), a methylol group (HO—CH₂—), a mercapto group (HS—), an isocyanate group (OCN—), a blocked isocyanate group, an alkoxysilyl group, an alkoxy titanate group, an alkoxy aluminate group an alkoxy zirconate group, an ethylenically unsaturated double bond, an ester bond, and a tetrazole group. An alkoxysilyl group is the most preferred reactive group. The hydrophilic polymer may have two or more reactive groups at one terminal thereof. When the hydrophilic polymer has two or more reactive groups per molecule, they may be the same or different.

The hydrophilic polymer preferably has a linking group between the repeating unit and the reactive group, on the repeating unit, or on the main chain. The linking groups A, L¹ L², and L³ are each preferably selected from —O—, —S—, —CO—, —NH—, —N═, an aliphatic group, an aromatic group, a heterocyclic group, and a combination thereof. The linking groups are each still preferably selected from —O—, —S—, —CO—, —NH—, and a combination containing —O—, —S—, —CO— or —NH—.

The hydrophilic polymer of formula (I) having a reactive group at one terminal thereof (hereinafter simply referred to as the polymer (I)) is prepared by, for example, radically polymerizing a hydrophilic monomer (e.g., acrylamide, acrylic acid or potassium 3-sulfopropyl methacrylate) in the presence of a chain transfer agent (see K. Hasuike and T. Endo, Radical Jyugo Handbook, N.T.S., Inc.) or an iniferter (see T. Otsu, Macromolecules, vol. 19, p. 287 (1986)). Examples of the chain transfer agent are 3-mercaptopropionic acid, 2-aminoethanethiol hydrochloride, 3-mercaptopropanol, 2-hydroxyethyl disulfide, and 3-mercaptopropyltrimethoxysilane. A radical polymerization initiator having a reactive group (e.g., carboxyl) may be used in place of the chain transfer agent in the radical polymerization of a hydrophilic monomer (e.g., acrylamide).

The hydrophilic polymer with a reactive group at one terminal thereof preferably has a weight average molecular weight of not more than 1,000,000, more preferably 1,000 to 1,000,000, even more preferably 2,000 to 500,000.

The polymer (I) has a reactive group at one of its terminals. In formula (I), R¹ and R² each represent a hydrogen atom or a hydrocarbon group with 8 or fewer carbon atoms. Examples of the hydrocarbon group include an alkyl group and an aryl group. The hydrocarbon group is preferably a straight-chain, branched or cyclic alkyl group with 8 or fewer carbon atoms, such as methyl, ethyl, propyl, butyl, pentyl, hexyl, heptyl, octyl, isopropyl, isobutyl, sec-butyl, tert-butyl, isopentyl, neopentyl, 1 methylbutyl, isohexyl, 2-ethylhexyl, 2-methylhexyl or cyclopentyl. R¹ and R² are each preferably a hydrogen atom, a methyl group or an ethyl group in view of effects and availability.

The hydrocarbon group may have a substituent. A substituted alkyl group is a combination of an alkylene group and a substituent. The substituent is a monovalent nonmetal atom or atomic group except hydrogen. Preferred examples of the substituent include a halogen atom (e.g., —F, —Br, —Cl or —I), an alkoxy group, an aryloxy group, an alkylthio group, an arylthio group, an N-alkylamino group, an N,N-dialkylamino group, an acyloxy group, an N-alkylcarbamoyloxy group, an N-arylcarbamoyloxy group, an acylamino group, a formyl group, an acyl group, a carboxyl group, an alkoxycarbonyl group, an aryloxycarbonyl group, a carbamoyl group, an N-alkylcarbamoyl group, an N,N-dialkylcarbamoyl group, an N-arylcarbamoyl group, an N-alkyl-N-arylcarbamoyl group, a sulfo group, a sulfonate group, a sulfamoyl group, an N-alkylsulfamoyl group, an N,N-dialkylsulfamoyl group, an N-arylsulfamoyl group, an N-alkyl-N-arylsulfamoyl group, a phosphono group, a phosphonate group, a dialkylphosphono group, a diarylphosphono group, a monoalkylphosphono group, an alkylphosphonate group, a monoarylphosphono group, an arylphosphonate group, a phosphonoxy group, a phosphonatoxy group, an aryl group, and an alkenyl group.

The alkylene moiety of the substituted alkyl group is a divalent organic group derived by removing any one of the hydrogen atoms of the above-described alkyl group having from 1 to 8 carbon atoms. The alkylene moiety preferably has a straight chain structure with 1 to 12 carbon atoms, a branched chain structure with 3 to 12 carbon atoms or a cyclic structure with 5 to 10 carbon atoms. Examples of suitable substituted alkyl group composed of a combination of the alkylene group and the substituent are chloromethyl, bromomethyl, 2-chloroethyl, trifluoromethyl, methoxymethyl, methoxyethoxyethyl, allyloxymethyl, phenoxymethyl, methylthiomethyl, tolylthiomethyl, ethylaminoethyl, diethylaminopropyl, morpholinopropyl, acetyloxymethyl, benzoyloxymethyl, N-cyclohexylcarbamoyloxyethyl, N-phenylcarbamoyloxyethyl, acetylaminoethyl, N-methylbenzoylaminopropyl, 2-hydroxyethyl, 2-hydroxypropyl, carboxypropyl, methoxycarbonylethyl, allyloxycarbonylbutyl, chlorophenoxycarbonylmethyl, carbamoylmethyl, N-methylcarbamoylethyl, N,N-dipropylcarbamoylmethyl, N-(methoxyphenyl)carbamoylethyl, N-methyl-N-(sulfophenyl)carbamoylmethyl, sulfobutyl, sulfonatobutyl, sulfamoylbutyl, N-ethylsulfamoylmethyl, N,N-dipropylsulfamoylpropyl, N-tolylsultamoylpropyl, N-methyl-N-(phosphonophenyl)sulfamoyloctyl, phosphonobutyl, phosphonatohexyl, diethylphosphonobutyl, diphenylphosphonopropyl, methylphosphonobutyl, methylphosphonatobutyl, tolylphosphonohexyl, tolylphosphonatohexyl, phosphonoxypropyl, phosphonatoxybutyl, benzyl, phenethyl, α-methylbenzyl, 1-methyl-1-phenylethyl, p-methylbenzyl, cinnamyl, allyl, 1-propenylmethyl, 2-butenyl, 2-methylallyl, 2-methylpropenylmethyl, 2-propynyl, 2-butynyl, and 3-butynyl.

A and L¹ each represent a single bond or an organic linking group. The organic linking group as A or L¹ is a polyvalent nonmetal linking group, specifically, a linking group composed of 1 to 60 carbon atoms, 0 to 10 nitrogen atoms, 0 to 50 oxygen atoms, 1 to 100 hydrogen atoms, and to 20 sulfur atoms. Even more specifically, examples of the linking group include the following constituent units and combinations thereof.

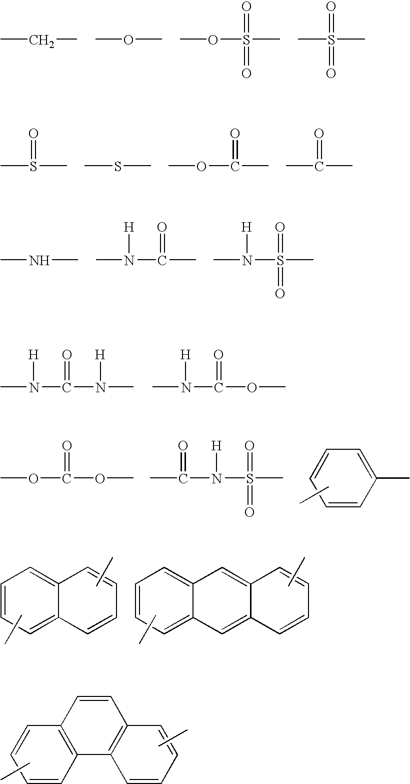

Y represents —NHCOR⁷, —CONH₂, —CON(R⁷)₂, —COR⁷, —OH, —CO₂M, —SO₃M, —PO₃M, —OPO₃M or —N(R⁷)₃Z¹, wherein R⁷ represents an alkyl, aryl or aralkyl group having 1 to 18 carbon atoms; M represents a hydrogen atom, an alkali metal, an alkaline earth metal or an onium group; and Z¹ represents a halide ion. A plurality of R⁷s as in —CON(R⁷)₂ or —N(R⁷)₃Z¹ may be connected to each other to form a ring that may contain a hetero atom, e.g., oxygen, sulfur or nitrogen. R⁷ may have a substituent. The substituent on R⁷ can be selected from those recited as examples of the substituent of the substituted alkyl group as R¹ or R².

Examples of suitable groups as R⁷ are methyl, ethyl, propyl, butyl, pentyl, hexyl, heptyl, octyl, isopropyl, isobutyl, sec-butyl, tert-butyl, isopentyl, neopentyl, 1-methylbutyl, isohexyl, 2-ethylhexyl, 2-methylhexyl, and cyclopentyl. Examples of M are hydrogen, lithium, sodium, potassium, calcium, barium, ammonium, iodonium, and sulfonium. Y is preferably —NHCOCH₃, —CONH₂, —COOH, —SO₃⁻K⁺, morpholyl or —OPO₃H₂.

Specific but non-limiting examples of the hydrophilic polymer (I) that are preferably used as component (a) in the invention are shown below (compound Nos. 1 through 38).

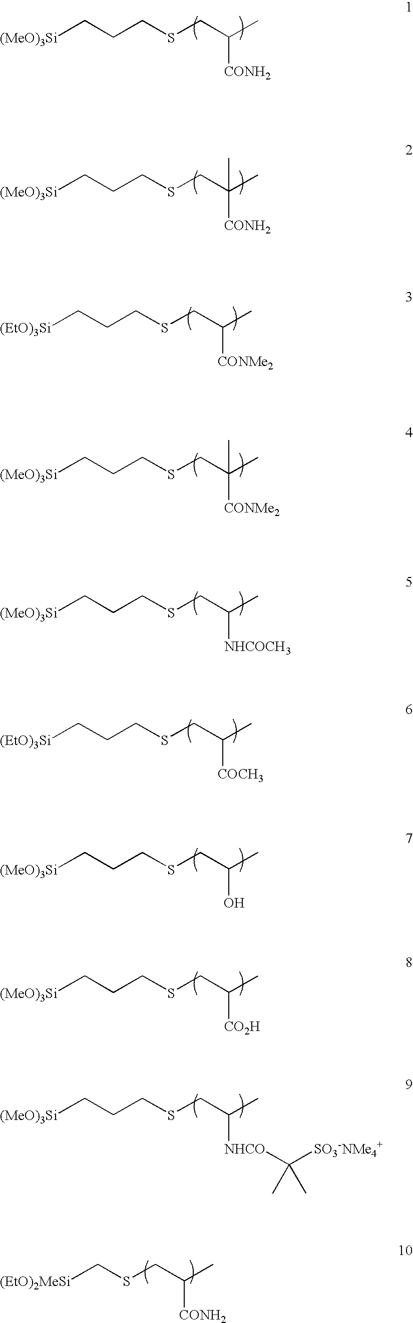

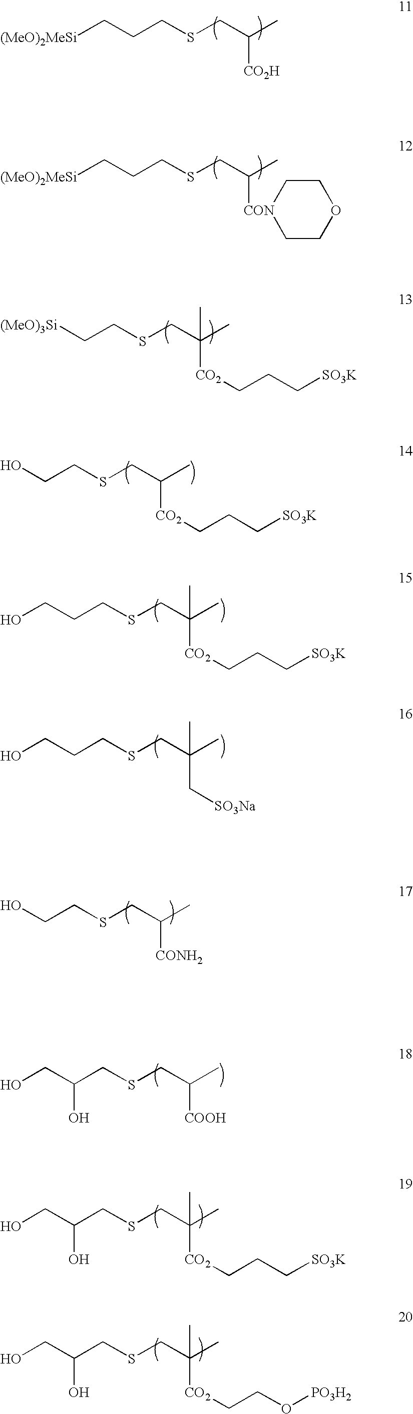

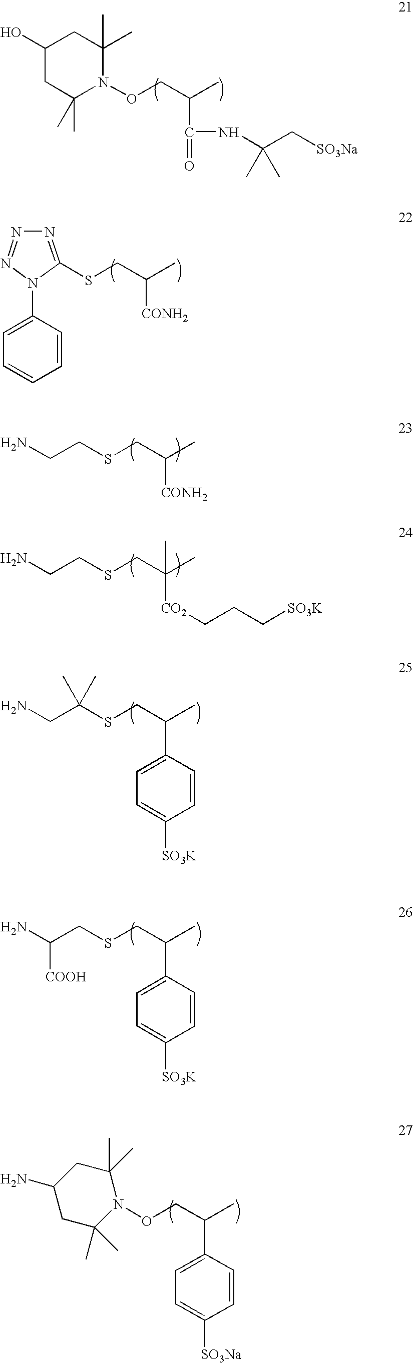

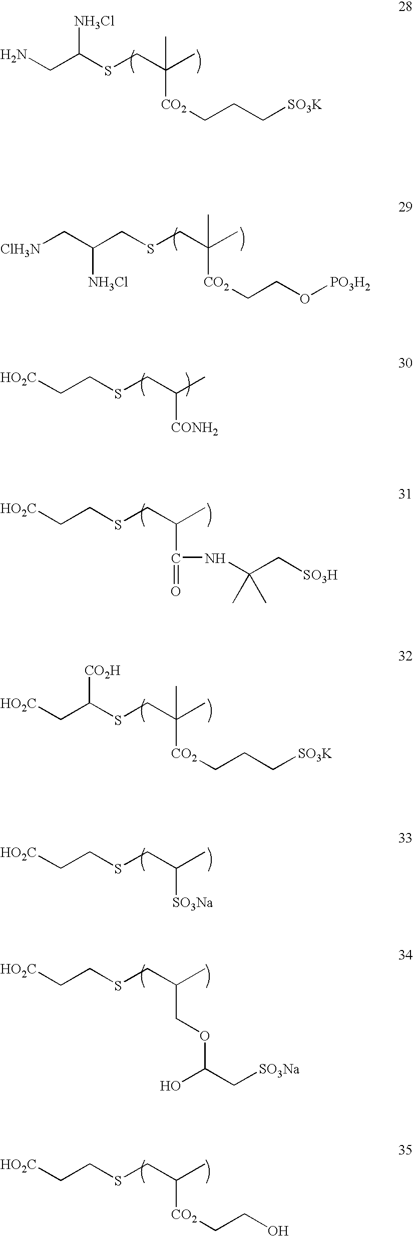

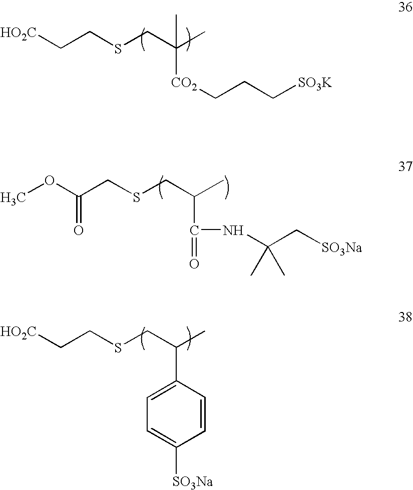

The above listed hydrophilic polymers (I) can be synthesized by radical polymerization of a radically polymerizable monomer represented by formula (i) below in the presence of a silane coupling agent represented by formula (ii) below that has chain transfer ability in radical polymerization. Since the silane coupling agent (ii) has chain transfer ability, the radical polymerization results in the formation of a polymer having a silane coupling group introduced into the terminal of the main chain thereof.

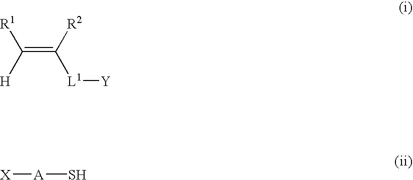

wherein A, R¹, R², L¹, X and Y are as defined above.

The monomer compound (i) and the silane coupling agent (ii) are commercially available and can easily be synthesized.

The hydrophilic polymer of formula (II) having at least two reactive groups can be a hydrophilic graft polymer comprising a trunk polymer having a functional group reactive with a metal alkoxide and a hydrophilic branch polymer grafted to the trunk polymer.

In formula (II), R³, R⁴, R⁵, and R⁶ each have the same meaning as R¹ and R² of formula (I); L² and L³ each have the same meaning as L¹ of formula (I); B is a partial structure represented by formula (III), in which R¹, R², L¹, and Y are as defined above; and X is as defined above.

The hydrophilic graft polymer is prepared by any process commonly known for the synthesis of graft polymers. More information about general synthesis of graft polymers are described in F. Ide, Graft Jyugo to sono Ohyo, Kobunshikankokai (1977) and The Society of Polymer Science, Japan (ed.), Shin-kobunshi Jikkengaku 2, Kobunshino Gosei Han-no, Kyoritsu Shuppan (1995).

Methods of synthesizing graft polymers are divided basically into three: (1) method involving polymerizing a branch monomer on a trunk polymer, (2) method involving bonding a branch polymer to a trunk polymer, and (3) method involving copolymerizing a branch polymer with a trunk polymer (macromonomer or macromer method). Any of the three methods can be used to form the hydrophilic graft polymer to be used in the invention. The third method (macromonomer method) is particularly preferred from the viewpoint of production suitability and film structure controllability.

Synthesis of graft polymers using macromonomers is described in Shin-kobunshi Jikkengaku 2, Kobunshino Gosei Han-no, supra and T, Yamashita, et al., Macromonomer no Kagaku to Kogyo, IPC Science and Technology Press, 1989. Specifically, the hydrophilic graft polymer for use in the invention can be synthesized by copolymerizing a hydrophilic macromonomer (a precursor of a hydrophilic branch polymer) prepared by the process described in the literature with a monomer having a functional group reactive with a crosslinking agent.

Of hydrophilic macromonomers usable in the invention, particularly useful are those derived from carboxyl-containing monomers such as acrylic acid and methacrylic acid; sulfonic acid macromonomers derived from 2-acrylamido-2-methylpropanesulfonic acid, vinylstyrenesulfonic acid and their salts; amide macromonomers derived from acrylamide, methacrylamide, etc.; amide macromonomers derived from N-vinylcarboxylic acid amides, such as N-vinylacetamide and N-vinylformamide; macromonomers derived from hydroxyl-containing monomers, such as hydroxyethyl methacrylate, hydroxyethyl acrylate, and glycerol monomethacrylate; and macromonomers derived from alkoxy- or ethylene oxide-containing monomers, such as methoxyethyl acrylate, methoxypolyethylene glycol acrylate, and polyethylene glycol acrylate. Monomers having a polyethylene glycol chain or a polypropylene glycol chain are also useful macromonomers. The weight average molecular weight of these macromonomers is in the range of 400 to 100,000, preferably in the range of 1,000 to 50,000, and more preferably in the range of 1,500 to 20,000. With the molecular weight of 400 or more, effective hydrophilicity is secured. With the molecular weight of more than 100,000, the macromonomer tends to have insufficient copolymerizability with the monomer forming the trunk polymer.

The monomer copolymerizable with the hydrophilic macromonomer has a functional group reactive with a crosslinking agent (hereinafter “reactive group”). Examples of the reactive group include a carboxyl group or a salt thereof, an amino group, a hydroxyl group, a phenolic hydroxyl group, an epoxy group (e.g., a glycidyl group), a methylol group, an isocyanate group, a blocked isocyanate group, and a group derived from a silane coupling agent. Commonly employed monomers include those described in S. Yamashita and T. Kaneko, Kakyozai Handbook, Taiseisya (1981), K. Kato, Shigaisen-koka System, Sogo Gijutu Center (1989), K. Kato, UV-EB Koka Handbook (Genryo-hen), Kobunshikankokai (1985), and K. Akamatsu, Shin Kankoseijyushi no Jissaigijutu, CMC, pp. 102-145 (1987). Specific examples of such monomers include (meth)acrylic acid and its alkali or amine salts, itaconic acid and its alkali or amine salts, 2-hydroxyethyl (meth)acrylate, hydroxypropyl (meth)acrylate, phenolic hydroxyl-containing compounds such as a compound represented by formula (1) below, glycidyl methacrylate, allyl glycidyl ether, N-methylolmethacrylamide, 2-methacryloyloxyethyl isocyanate, blocked isocyanate compounds such as a compound represented by formula (2) below, a vinylalkoxysilane, and a γ-methacryloxypropyltrialkoxysilane.

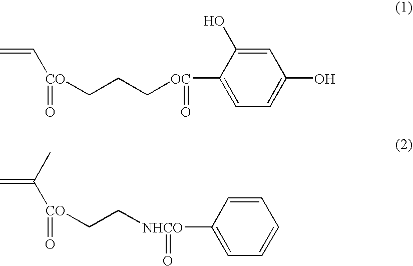

The graft polymer preferably has a weight average molecular weight of less than 1,000,000, more preferably more than 1,000, even more preferably from 5,000 to 500,000. With the molecular weight less than 1,000,000, the hydrophilic graft polymer is sufficiently soluble in a solvent to provide a coating composition with good handling properties, i.e., a sufficiently low viscosity to be applied to form a uniform coating film.

The hydrophilic polymers contain a hydrophilic functional group that develops hydrophilic properties and is represented by Y in the formula. Preferably, the higher the density of this functional group is, the higher the surface hydrophilicity gets. The hydrophilic functional group density, being represented by the number of moles of the functional group per one gram of the hydrophilic polymer, is preferably in the range of 1 to 30 meq/g, more preferably in the range of 2 to 20 meq/g, and even more preferably in the range of 3 to 15 meq/g.

The copolymerization ratio of the hydrophilic polymer (II) is selected arbitrarily so that the density of the hydrophilic functional group Y may be in the above recited range. Taking the mole numbers of the monomer unit containing B and the monomer unit containing X as m and n, respectively, the copolymerization ratio m/n is preferably in the range of 30/70 to 99/1, more preferably in the range of 40/60 to 98/2, even more preferably in the range of 50/50 to 97/3. As long as the ratio of m is 30 mol % or less, hydrophilic property is insufficient. As long as the ratio of n is 1 mol % or less, the amount of the reactive group is not enough to show sufficient cure to provide a film with sufficient strength.

The hydrophilic polymer forms a cross-linked coating film in a state mixed with a hydrolysis and polycondensation product of a metal alkoxide. The hydrophilic polymer as an organic component is responsible for development of the coating film strength and flexibility. When the hydrophilic polymer has a viscosity in the range of 0.1 to 100 cPs, preferably in the range of 0.5 to 70 cPs, more preferably in the range of 1 to 50 cPs, in a 5% aqueous solution at 25° C., it provides satisfactory film properties.

(Metal Alkoxide)

The metal alkoxide used in the invention is a hydrolyzable and polymerizable compound having, in its structure, a functional group capable of hydrolysis and polycondensation to perform the function as a crosslinking agent. The metal alkoxide molecules per se are polycondensed with each other to form a tough cross-linked coating film having a cross-linked structure while forming chemical bonds with the hydrophilic polymer. The metal alkoxide can be represented by formula (IV): wherein R⁸ represents a hydrogen atom, an alkyl group or an aryl group; R⁹ represents an alkyl group or an aryl group; Z represents Si, Al, Ti or Zr; and m represents an integer of 0 to 2. The alkyl group as represented by R⁸ and R⁹ preferably contains 1 to 4 carbon atoms. The alkyl or aryl group may have a substituent group and examples of an adoptable substituent group are a halogen atom, an amino group or a mercapto group. The metal alkoxide is a low molecular compound, preferably having a molecular weight less than 2000.

(R⁸)ₘ-Z-(OR⁹)₄₋ₘ (IV)

Specific examples of the hydrolyzable compound represented by formula (IV) are shown below but are not limited in the present invention. In the case Z is Si, that is, the hydrolysable compounds containing silicon, are, for example, trimethoxysilane, tetramethoxysilane, tetraethoxysilane, tetrapropoxysilane, methyltrimethoxysilane, dimethyldimethoxysilane, γ-chloropropyltriethoxysilane, γ-mercaptopropyltrimethoxysilane, γ-aminopropyltriethoxysilane, phenyltrimethoxysilane, diphenyldimethoxysilane, and the like. Preferred of them are trimethoxysilane, tetramethoxysilane, tetraethoxysilane, methyltrimethoxysilane, dimethyldimethoxysilane, phenyltrimethoxysilane, and the like.

In the case Z is Al, that is, the hydrolyzable compounds containing aluminium, are, for example, trimethoxyaluminate, triethoxyaluminate, tripropoxyaluminate, tetraethoxyaluminate, and the like. In the case Z is Ti, that is, the hydrolyzable compounds containing titanium, are, for example, trimethoxytitanate, tetramethoxytitanate, triethoxytitanate, tetraethoxytitanate, tetrapropoxytitanate, chlorotrimethoxytitanate, chloroethoxytitanate, ethyltrimethoxytitanate, methyltriethoxytitanate, ethyltriethoxytitanate, diethyldiethoxytitanate, phenyltrimethoxytitanate, phenyltriethoxytitanate, and the like. In the case Z is Zr, that is, the hydrolyzable compounds containing zirconium, are, for example, zirconate corresponding to the hydrolyzable compounds containing titanium recited above.

[Catalyst]

The hydrophilic layer in the present invention may use Lewis acid catalyst comprising inorganic acid (e.g., nitric acid, hydrochloric acid, and the like), base (e.g., ammonia and the like), or metal complex to promote the gelation. In particular, the metal complex catalyst is preferred and the metal complex is formed of a metal element selected from the groups 2A, 3B, 4A, and 5A of the Periodic Table and an oxo- or hydroxy oxygen-containing compound selected from a β-diketone, a keto ester, a hydroxycarboxylic acid or an ester thereof, an amino alcohol, and an enol type active hydrogen compound.

Of the constituting metal elements, Mg, Ca, St, Ba, and the like as the group 2A elements, Al, Ga, and the like as the group 3B elements, Ti, Zr, and the like as the group 4A elements, and V, Nb, Ta, and the like as the group 5A elements are preferred, each of which forms a complex having an excellent catalytic effect Particularly preferred complexes are Zr, Al or Ti complexes.

Examples of the oxo- or hydroxyl oxygen-containing compound forming the ligand of the metal complex catalyst include β-diketones such as acetylacetone (pentane-2,4-dione) and heptane-2,4-dione; keto esters such as methyl acetoacetate, ethyl acetoacetate, and butyl acetoacetate; hydroxycarboxylic acids and esters thereof such as lactic acid, methyl lactate, salicylic acid, ethyl salicylate, phenyl salicylate, malic acid, tartaric acid, and methyl tartrate; keto alcohols such as 4-hydroxy-4-methyl-2-pentanone, 4-hydroxy-2-pentanone, 4-hydroxy-4-methyl-2-pentanone, and 4-hydroxy-2-heptanone; amino alcohols such as monoethanolamine, N,N-dimethylethanolamine, N-methylmonoethanolamine, diethanolamine, and triethanolamine; enol type active hydrogen compounds such as methylolmelamine, methylolurea, methylolacrylamide, and diethyl malonate; and compounds derived by bonding a substituent to the methyl, methylene or carbonyl carbon of acetylacetone (hereinafter referred to as acetylacetone derivatives).

Acetylacetone and the acetylacetone derivatives are preferred ligand compounds. Examples of the substituent on the methyl group of acetylacetone are an alkyl group, an acyl group, a hydroxyalkyl group, a carboxyalkyl group, an alkoxy group, and an alkoxyalkyl group each of which contains 1 to 3 carbon atoms and may be straight or branched. Examples of the substituent on the methylene group of acetylacetone include a carboxyl group and a carboxy- or hydroxy-alkyl group which contains 1 to 3 carbon atoms and may be straight or branched. Examples of the substituent on the carbonyl carbon of acetylacetone include an alkyl group having 1 to 3 carbon atoms. When the carbonyl carbon is substituted, the carbonyl oxygen has a hydrogen atom added to become a hydroxyl group.

Examples of preferred acetylacetone derivatives include ethyl carbonylacetone, n-propylcarbonylacetone, isopropylcarbonylacetone, diacetylacetone, 1-acetyl-1-propionyl-acetylacetone, hydroxyethylcarbonylacetone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone, and diacetone alcohol. Particularly preferred ligand compounds are acetylacetone and diacetylacetone. The complex between acetylacetone or a derivative thereof and the metal is a mononuclear complex having 1 to 4 molecules of acetylacetone or a derivative thereof coordinated per metal element. When the number of the coordination positions of the center metal is larger than the total number of bonds formed with an acetylacetone or acetylacetone derivative ligand, the rest of the positions may be occupied by a ligand widely used in general complexes such as an aquo (H₂O) ion, a halide ion, a nitro group or an ammonio group.

Examples of preferred metal complexes include tris(acetylacetonato)aluminum, bis(acetylacetonato)aquoaluminum, mono(acetylacetonato)aluminum chloro complexes, bis(diacetylacetonato)aluminum complexes, ethylacetoacetatoaluminum diisopropylate, tris(ethylacetoacetato)aluminum, cyclic aluminum oxide isopropylate, tris(acetylacetonato)barium, bis(acetylacetonato)titanium complexes, tris(acetylacetonato)titanium complexes, di(isopropoxy)bis(acetylacetonato)titanium, tris(ethylacetoacetato)zirconium complexes, and zirconium trisbenzoate complexes. They exhibit high stability in a waterborne coating system and an excellent gelation promoting effect in sol-gel reaction when heat dried. Particularly preferred of them are ethylacetoacetatoaluminum diisopropylate, tris(ethylacetoacetato)aluminum, bis(acetylacetonato)titanium complexes, and tris(ethylacetoacetato)zirconium complexes.

The counter ions in the examples of complex salts, while not described above, are arbitrary as long as the complex compounds are water soluble salts with charge neutrality. For example, salt forms securing stoichiometric neutrality, such as a nitrate, a halogen acid salt, a sulfate, and a phosphate, are used. Detailed information on the behavior of metal complexes in silica sol gel reaction is given in J. Sol-Gel Sci. and Tec., vol. 16, p. 209 (1999). The reaction mechanism is assumed to be as follows. The metal complex in a coating composition takes on a coordination structure and is therefore stable. In dehydrating condensation reaction started in the step of heat drying following application of the coating composition, the complex is considered to act like an acid catalyst to promote crosslinking. Anyway, using the metal complex improves coating composition's stability with time and coating film properties as well as secures high hydrophilicity and durability of the resulting surface layer.

[Inorganic Fine Particle]

The hydrophilic layer of the invention can contain inorganic fine particles for improving hydrophilicity, protecting the coating film against cracking, and improving film strength.

Examples of suitable inorganic fine particles include particles of silica, alumina, magnesium oxide, titanium oxide, magnesium carbonate or calcium alginate, or mixtures thereof.

The inorganic fine particles preferably have an average particle size of 5 nm to 10 μm, more preferably 0.5 to 3 μm. With the average particle size falling within above-mentioned range, the particles are stably dispersed in the hydrophilic layer to keep the sufficient film strength of the hydrophilic layer to form a hydrophilic member with high durability as well as surface hydrophilicity.

A colloidal silica dispersion is particularly preferred as above-mentioned inorganic fine particles. It is easily available on the market.

The amount of the inorganic fine particles to be added is preferably 80% by weight or less, more preferably 50% by weight or less, based on the total solids content of the hydrophilic layer.

[Other Component]

Various additives, if necessary, which may be incorporated into the coating composition for forming the hydrophilic layer of the structure in the present invention are described below.

### (1) Surface Active Agent

Surface active agents may be added to the coating composition for forming the hydrophilic layer of the structure in the present invention.

Examples of surface active agents include those described in JP-A-62-173463 and JP-A-62-183457. Exemplary examples are anionic surface active agents such as dialkylsulfosuccinates, alkylnaphthalenesulfonates, fatty acid salts, and the like; nonionic surface active agents such as polyoxyethylene alkyl ethers, polyoxyethylene alkyl allyl ethers, acetylene glycols, polyoxyethylene polyoxypropylene block copolymers, and the like; and cationic surface active agents such as alkylamine salts, quaternary ammonium salts, and the like. Organofluoro compounds may be used in place of above-mentioned surface active agents. The organofluoro compounds are preferably hydrophobic. The organofluoro compounds include, for example, fluorine-containing surface active agents, oily fluorine-containing compounds (e.g., fluorinated oil), and solid fluororesin compounds (e.g., tetrafluoroethylene resin). Specific examples are described in JP-B 57-9053, cols. 8-17 and JP-A-62-135826.

(2) UV Absorbers

In the present invention, UV absorbers can be used from the viewpoint of improving weather resistance and durability of the hydrophilic layer form of the structure.

Examples of the UV absorbers include benzotriazole compounds, such as those described in JP-A-58-185677, JP-A-61-190537, JP-A-2-782, JP-A-5-197075, and JP-A-9-34057; benzophenone compounds such as those described in JP-A-46-2784, JP-A-5-194483, and U.S. Pat. No. 3,214,463; cinnamic acid compounds such as those described in JP-B-48-30492, JP-B-56-21141, and JP-A-10-88106; triazine compounds such as those described in JP-A-4-298503, JP-A-8-53427, JP-A-8-239368, JP-A-10-182621, and JP-T-8-501291; the compounds described in Research Disclosure No. 24239; and compounds that absorb ultraviolet light to emit fluorescence, so called fluorescent whitening agents, typified by stilbene compounds and benzoxazole compounds.

The amount of the UV absorber to be added is decided as appropriate to the intended use. In general, it is preferably in the range of 0.5 to 15% by weight on a solid basis.

(3) Antioxidant

Antioxidants can be added to the coating composition to improve the stability of the hydrophilic layer of the structure in the present invention. Examples of the antioxidants include those described in European Patents 223739A, 309401A, 309402A, 310551A, 310552A, and 459416A, German Patent DE 3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

The amount of the antioxidant to be added is decided as appropriate for the intended use. It is preferably in the range of 0.1 to 8% by weight on a solid basis.

(4) Solvent

In case of forming the hydrophilic layer of the structure in the present invention, it is effective to add an organic solvent to the coating composition for forming the hydrophilic layer as appropriate to secure capability of forming a uniform coating film on a substrate.

Examples of the solvent include ketone solvents, e.g., acetone, methyl ethyl ketone, diethyl ketone, and the like; alcohol solvents, e.g., methanol, ethanol, 2-propanol, 1-propanol, 1-butanol, tert-butanol, and the like; chlorinated solvents, e.g., chloroform, methylene chloride, and the like; aromatic solvents, e.g., benzene, toluene, and the like; ester solvents, e.g., ethyl acetate, butyl acetate, isopropyl acetate, and the like; ether solvents, e.g., diethyl ether, tetrahydrofuran, dioxane, and the like; and glycol ether solvents, e.g., ethylene glycol monomethyl ether, ether, ethylene glycol dimethyl ether, and the like.

The effective amount of the organic solvent to be added is such that gives rise to no problem associated with VOC (volatile organic compound). Such an effective amount is preferably 0 to 50% by weight, more preferably 0 to 30% by weight, based on the total coating composition at the time of forming the hydrophilic member.

(5) Polymer

Various polymers may be added to the coating composition for forming the hydrophilic layer of the structure in the present invention within a range those polymers do not impair the hydrophilic properties of the layer to control the film properties of the hydrophilic layer. Examples of the polymers include acrylic polymers, polyvinyl butyral resins, polyurethane resins, polyamide resins, polyester resins, epoxy resins, phenol resins, polycarbonate resins, polyvinyl butyral resins, polyvinyl formal resins, shellac, vinyl resins, acrylic resins, rubber resins, waxes, and other natural resins. These polymers may be used either individually or as a combination thereof. Among them vinyl copolymers obtained by copolymerization of an acrylic monomer are preferred. For the copolymer composition of the polymer binding material, copolymers having a carboxylic group-containing monomer, an alkylester methacrylate or an alkylester acrylate as a structural unit are preferably used.

If necessary, other additives may be used, for example, a leveling additive, a matting agent, waxes for controlling the film properties, and a tackifier for improving adhesion to the substrate within ranges that do not impair the hydrophilic property.

Specific examples of tackifiers include the high-molecular adhesive polymers described in JP-A-2001-49200, pp. 5 to 6 (e.g., copolymers comprising (meth)acrylic acid esters with alcohols having a C1 to C20 alkyl group, (meth)acrylic acid esters with C3 to C14 alicyclic alcohols, and (meth)acrylic acid esters with C6 to C14 aromatic alcohols) or low-molecular adhesive resins containing a polymerizable unsaturated bond.

[Plastic Substrate]

The plastic substrates used in the invention are not particularly limited. Examples of the plastic substrates include films or sheets of polyester, polyethylene, polypropylene, cellophane, cellulose triacetate, cellulose diacetate, cellulose acetate butyrate, polyvinyl chloride, polyvinylidene chloride, polyvinyl alcohol, ethylene vinyl alcohol, polystyrene, polycarbonate, polymethylpentene, polysulfone, polyether ketone, acryl, nylon, fluorine resin, polyimide, polyetherimide, and polyether sulfone. Among those plastic substrates, polyesters (e.g., polyethylene terephthalate and polyethylene naphthalate), cellulosic resins (e.g., polycarbonate, cellulose triacetate, and cellulose diacetate) and the like are preferred. Transparent plastic substrates are preferably used in optical applications, but in some applications, translucent or printed substrates can be used. The thickness of the plastic substrate varies depending on another substrate to be superposed. For use on a substrate with a curved surface, thin plastic films of about 6 to 50 μm in thickness are preferred. For use on a flat substrate or for applications where strength is demanded, plastic films with a thickness of 50 to 400 μm are used.

For the purpose of improving the adhesion of the plastic substrate to the hydrophilic layer, one or both sides of the plastic substrate may be surface-hydrophilized by oxidation or surface roughening. Examples of hydrophilization by oxidation include corona discharge treatment, glow discharge treatment, chromic acid treatment (wet type), flame treatment, hot air treatment, ozone/UV irradiation treatment, and the like. Hydrophilization by surface roughening can be effected by mechanical treatment such as sand blasting, brush polishing, and the like.

In addition, one or more primer layers may be applied to the substrate. Hydrophilic resins or water dispersible latices can be used to form a primer layer.

Examples of the hydrophilic resins include polyvinyl alcohol (PVA), cellulosic resins such as methyl cellulose (MC), hydroxyethyl cellulose (HEC), and carboxymethyl cellulose (CMC), chitins, chitosans, starch, resins having an ether linkage such as polyethylene oxide (PEO), polyethylene glycol (PEG), and polyvinyl ether (PVE), and carbamoyl-containing resins, such as polyacrylamide (PAAM) and polyvinyl pyrrolidone (PVP). Additionally, carboxyl-containing polymers, such as polyacrylates, maleic acid resins, and alginates, and gelatins are also usable.

Among them, preferred are one or more of polyvinyl alcohol resins, cellulosic resins, resins with an ether linkage, carbamoyl-containing resins, carboxyl-containing resins, and gelatins. Polyvinyl alcohol resins and gelatins are particularly preferred.

Examples of the water dispersible latices include acrylic latices, polyester latices, NBR resins, polyurethane latices, polyvinyl acetate latices, SBR resins, and polyamide latices. Acrylic latices are particularly preferred.

The above-described hydrophilic resins or water dispersible latices can be used individually, as a combination of the hydrophilic resins, as a combination of the water dispersible latices, or as a combination of the hydrophilic resin and the water dispersible latex.

Where necessary, the hydrophilic resin or water dispersible latex may be used in combination with a crosslinking agent therefor. Generally useful thermal crosslinking agents are described in Kakyozai Handbook, supra. The crosslinking agent to be used in the invention is not particularly limited as long as it contains at least two functional groups and is capable of effectively crosslinking the hydrophilic resin or water dispersible latex used. Specific examples of suitable thermal crosslinking agents are polycarboxylic acids, e.g., polyacrylic acid; amine compounds, e.g., polyethyleneimine; polyepoxy compounds, e.g., ethylene (or propylene) glycol diglycidyl ether, tetraethylene glycol diglycidyl ether, nonaethylene glycol diglycidyl ether, polyethylene (or polypropylene) glycol glycidyl ether, neopentyl glycol diglycidyl ether, 1,6-hexanediol diglycidyl ether, trimethylolpropane triglycidyl ether, and sorbitol polyglycidyl ether; polyaldehyde compounds, e.g., glyoxal and terephthalaldehyde; polyisocyanate compounds, e.g., tolylene diisocyanate, hexamethylene diisocyanate, diphenylmethane isocyanate, xylylene diisocyanate, polymethylenepolyphenyl isocyanate, cyclohexyl diisocyanate, cyclohexanephenylene diisocyanate, naphthalene 1,5-diisocyanate, isopropylbenzene 2,4-diisocyanate, and a polypropylene glycol/tolylene diisocyanate adduct; blocked polyisocyanate compounds; silane coupling agents, e.g., tetraalkoxysilanes; metallic crosslinking agents, e.g., acetylacetonato complexes of aluminum, copper or iron (III); and polymethylol compounds, e.g., trimethylolmelamine and pentaerythritol. Of these thermal crosslinking agents, water soluble ones are preferred in view of ease of preparing a coating composition and also for avoiding reduction of hydrophilicity of the resulting hydrophilic layer.

The hydrophilic resin and/or water dispersible latex can be used in a primer layer in a total amount preferably of from 0.01 to 20 g/m², more preferably of from 0.1 to 10 g/m².

[Adhesive Layer]

According to an adhesive layer of the present invention, an adhesive compound, which is a pressure sensitive adhesive, is preferably used. Examples of the adhesive compound include those commonly used in adhesive sheets, such as rubber adhesives, acrylic adhesives, silicone adhesives, vinyl ether adhesives, styrene adhesives and the like.

Where optical transparency is required, the adhesive compound should be chosen from these for optical applications. Where a coloring, a translucency or a texture (e.g., matte finish) is required, such can be achieved by not only texturing the substrate per se but also adding a dye or organic or inorganic powder to the adhesive compound.

In the case where an adhesive granting compound is needed, an adhesive granting resin, for example, rosin resins, terpene resins, petroleum resins, styrene resins, and hydrogenated products of these resins can be used respectively alone or a combination thereof.

The adhesive force of the adhesive compounds used in the invention is what is generally called “strong adhesion,” i.e., 200 g/25 mm or more, preferably 300 g/25 mm or more, and more preferably 400 g/25 mm or more. The term “adhesive force” as used herein means a value measured by a 180 degree peel test in accordance with JIS Z0237.

[Release Layer]

According to a preferred aspect of the present invention, a release layer may be formed. The release layer preferably contains a releasing agent to get a releasing effect. Examples of releasing agents include generally a silicone releasing agent comprising organopolysiloxanes, fluorine compounds, long chain alkyl-modified polyvinyl alcohols, and long chain alkyl-modified polyethyleneimines. In addition, various releasing agents (e.g., hot melt type releasing agents, monomer type releasing agents that cure releasing monomers through radical polymerization, cationic polymerization, polycondensation, etc.), copolymer resins (e.g., silicone-containing acrylic copolymer resin, fluorine-containing acrylic copolymer resin, and urethane-silicone-fluorine copolymer resin), silicone resin/acrylic resin resin blend, and fluororesin/acrylic resin resin blend are used. The release layer may be a hard coat release layer formed by curing a curing composition containing any one atom of a fluorine atom and/or a silicon atom and a compound having an active energy ray-polymerizable group.

If desired, a protective layer may be provided on the hydrophilic layer. The protective layer functions to protect the surface of the hydrophilic layer from being scratched during handling, transportation or storage or from being reducing the hydrophilic property due to adhesion of dust and dirt. The release layer or the hydrophilic polymer layer used in the primer layer can be used as the protective layer. The protective layer is stripped off after the hydrophilic member structure is stuck to another substrate which will be described in detail later.

[Configuration of the Structure]

According to a preferred aspect of the present invention, a glass structure is formed by attaching the hydrophilic member forming of the plastic substrate coated with the above-mentioned hydrophilic coating film to the surface of the glass between the adhesive layer.

The glass used in the invention is not particularly limited, but the glass such as soda glass, lead glass, borosilicate glass, and the like may be used. According to the purpose, float plate glass, template glass, frosted glass plate, wired glass, line wire glass, strengthened glass, laminated glass, double-glazed glass, evacuated glass, security glass, and highly insulating Low-E double-glazed glass can be used.

The hydrophilic structure comprising the release layer, a preferred aspect of the present invention, can be supplied in the form of sheet, roll, or ribbon or in the form of cut in advance to attach to the substrate which will be described in detail later.

[Surface Free Energy]

The degree of hydrophilic property of a surface of the hydrophilic layer is commonly measured in terms of water droplet contact angle. However, in the cases where a surface has very high hydrophilic property as in the present invention, the water droplet contact angle can be 10° or smaller and, in some cases, 5° or even smaller. This means that the method of comparing hydrophilicity by water droplet contact angle measurement has a limit. A method of more precisely evaluating hydrophilicity of the surface of a solid is a measurement of surface free energy. In the present invention, the Zisman-plot method, one of various methods of surface free energy measurement so far proposed, is adapted. More specifically, an inorganic electrolyte (e.g., magnesium chloride) aqueous solution is used because of its nature of having an increasing surface tension with an increase in concentration. After measuring a contact angle in air at a room temperature using the aqueous solution, the surface tension of the aqueous solution is plotted as the abscissa, and the cosine of the measured contact angle cos θ is plotted as the ordinate. The resulting plot of the aqueous solution with a varied concentration is a straight line. The value of surface tension where the cosine of the contact angle is unity (i.e., contact angle=0°) is taken as a surface free energy of the solid. The surface tension of water is 72 mN/m. The larger the surface free energy is, the higher the hydrophilic property gets.

A hydrophilic layer having a surface free energy in the range of 70 to 95 mN/m, preferably in the range of 72 to 93 mN/m, more preferably in the range of 75 to 90 mN/m, as measured by the above-described method can be the to have high hydrophilic property and exhibit excellent performance.

Transparency is of importance for the glass structure formed by coating with a hydrophilic coating film of the invention when applied to a window glass and the like from the viewpoint of ensuring visibility. The hydrophilic coating film of the invention has an excellent transparency and the transparency is not lost even with an increased thickness therefore the hydrophilic coating film can have both transparency and durability.

The thickness of the hydrophilic coating film of the invention is preferably in the range of 0.01 to 100 μm, more preferably in the range of 0.05 to 50 μm, even more preferably in the range of 0.1 to 20 μm. Thicknesses of 0.01 μm or larger preferably assure sufficient durability as well as hydrophilic property. Thicknesses of 100 μm or smaller give rise to no film forming problems, such as cracking, which is preferable.

The transparency can be evaluated by measuring light transmittance in a visible light region (400 to 800 nm) with a spectrophotometer. The light transmittance is preferably in the range of 70 to 100%, more preferably in the range of 75 to 9%, even more preferably in the range of 80 to 95%. When the light transmittance is in the above range, the structure formed by coating with the hydrophilic coating film is applicable to a broad range of applications without obstructing a clear view through it.

Forming of the hydrophilic coating film of the structure in the present invention is obtained by coating the hydrophilic coating composition to an appropriate plastic substrate and heat and dry. The temperature and time of heating are not particularly limited as long as the solvent in the coating composition (sol) is removed to form a firm coating film. In view of production suitability, nevertheless, the heating is preferably carried out at 150° C. or lower for 1 hour or shorter.

The glass structure, one of the preferred aspects of the invention, is applicable in expectation of its anti-fogging effect to transparent glass as a substrate. Applications in which the glass structure having anti-fogging properties is suitably used include mirrors such as automotive rearview mirrors, bathroom mirrors, washstand mirrors, dentist's mirrors, and road mirrors; lenses such as spectacles lenses, optical lenses, camera lenses, endoscope lenses, lighting lenses, semiconductor lenses, and copier lenses; prisms; window glass for buildings and lookout towers; window glass for various vehicles including cars, railcars, airplanes, ships, submersible vessels, snow cars, ropeway gondolas, Ferris wheel gondolas, and spaceships; windshields for various vehicles including cars, railcars, airplanes, ships, submersible vessels, snow cars, snowmobiles, motorcycles, ropeway gondolas, Ferris wheel gondolas and spaceships; protective goggles, sport goggles, visors of protective masks, visors of sport masks, visors of protective helmets; cabinet glass for retail display of frozen foods; glass covers for measurement instruments.

The glass structure is applicable in expectation of its cleaning effect to exteriors and coatings of architectural materials, exterior materials, interior materials, window frames, window glass, structural materials, and vehicles; exteriors of machinery or articles; dustproof covers or coatings; exteriors or coatings of traffic signs, various display devices, advertising pillars, roadway noise barriers, railway noise barriers, bridges, and guardrails; interiors and coatings of tunnels; insulators; solar cell covers; heat collecting covers of solar water heaters; green houses; vehicle light protective covers; housing equipments; lavatory pans; bath tubs; washstand tops; lighting fixtures; lighting covers; kitchen utensils; tableware; dishwashers; dish dryers; sinks; cooking range; kitchen hoods; and ventilation fans.

The hydrophilic member structure having the release layer, one of the preferred aspects of the invention, is applicable in expectation of its anti-fogging effect to transparent substrate. Glass, plastic used for the plastic substrate, and the like are suitably used as a material for the transparent substrate. Any of soda glass, lead glass, borosilicate glass, etc. can be used as a glass substrate. According to the purpose, float plate glass, template glass, frosted glass plate, wired glass, line wire glass, strengthened glass, laminated glass, double-glazed glass, evacuated glass, security glass, and highly insulating Low-E double-glazed glass can be used. Applications in which the hydrophilic member having anti-fogging properties is suitably used include mirrors such as automotive rearview mirrors, bathroom mirrors, washstand mirrors, dentist's mirrors, and road mirrors; lenses such as spectacles lenses, optical lenses, camera lenses, endoscope lenses, lighting lenses, semiconductor lenses, and copier lenses; prisms; window glass for buildings and lookout towers; window glass for various vehicles including cars, railcars, airplanes, ships, submersible vessels, snow cars, ropeway gondolas, Ferris wheel gondolas, and spaceships; windshields for various vehicles including cars, railcars, airplanes, ships, submersible vessels, snow cars, snowmobiles, motorcycles, ropeway gondolas, Ferris wheel gondolas, and spaceships; protective goggles, sport goggles, visors of protective masks, visors of sport masks, visors of protective helmets; cabinet glass for retail display of frozen foods; glass covers for measurement instruments; and films applied to the surface of the articles recited above.

The structure of the surface-hydrophilic member is applicable in expectation of its cleaning effect to a substrate such as metals, ceramics, glass, plastic, wood, stone, cement, concrete, fiber, fabric, and combinations or laminates of the materials recited. Applications in which the surface-hydrophilic member having cleaning effect is suitably used include exteriors and coatings of architectural materials, exterior materials, interior materials, window frames, window glass, structural materials, and vehicles; exteriors of machinery or articles; dustproof covers or coatings; exteriors or coatings of traffic signs, various display devices, advertising pillars, roadway noise barriers, railway noise barriers, bridges, and guardrails; interiors and coatings of tunnels; insulators; solar cell covers; heat collecting covers of solar water heaters; green houses; vehicle light protective covers; housing equipments; lavatory pans; bath tubs; washstand tops; lighting fixtures; lighting covers; kitchen utensils; tableware; dishwashers; dish dryers; sinks; cooking range; kitchen hoods; ventilation fans; and films applied to the surface of the articles recited above.

### EXAMPLES

The present invention will now be described in detail with reference to Examples, but the invention is limited thereto.

### Example 1

A support is prepared by forming an adhesive layer and a release layer described below in that order on a back side of a 50 μm thick of polyethylene terephthalate substrate and a surface of the support was subjected to glow discharge treatment to have a hydrophilized surface. A hydrophilic layer coating composition described below was applied to the hydrophilized surface by means of a bar coater and dried in an oven at 100° C. for 10 minutes to form a hydrophilic layer having a dry-coating thickness of 1.0 g/m² and a structure of hydrophilic member was produced. The resulting hydrophilic member had a surface free energy of 87 mN/m, proving to have a very highly hydrophilic surface. The hydrophilic layer had a visible light transmittance of 95% (measured with a spectrophotometer U3000 from Hitachi, Ltd.).

<Adhesive Layer>

A commercially available acrylic emulsion adhesive compound (Emapol R-140, manufactured by Ipposha Oil Industries Co., Ltd.) was applied to the back side of the substrate to have a dry thickness of about 20 μm and dried to form a adhesive layer.

<Release Layer>

To 100 parts by weight of a 50% by weight solution of methyl ethyl ketone of polyglycidyl methacrylate (polystyrene equivalent Mw: 12,000) was added a solution of 150 parts by weight of trimethylolpropane triacrylate (Aronix M-309, manufactured by To a Gosei Co., Ltd.), 6 parts by weight of a photo radical polymerization initiator (Irgacure 184, manufactured by Ciba Geigy), 6 parts by weight of a photo cationic polymerization initiator (Rhodosil 2074, manufactured by Rhodia), and 10 parts by weight of Megafac 531A (manufactured by Dainippon Ink & Chemicals, Inc.) in 30 parts by weight of methyl isobutyl ketone and mixed while stirring to prepare a coating composition for a release layer.

The coating composition for a release layer was applied on the adhesive layer by extrusion coating to have a thickness of 30 μm, dried, and irradiated with ultraviolet light (1 J/cm²) to form a release layer.

<Coating Composition (1)>

| | |
|---|---|
| 20% by weight aqueous solution of Colloidal silica | 100 g |
| dispersion (Snowtex C) | |
| Sol-gel liquid prepared as follows | 500 g |
| 5% by weight aqueous solution of anionic surface | 30 g |
| active agent described below | |
| Purified water | 450 g |

Anionic Surface Active Agent:

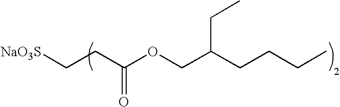

<Sol Gel Liquid>

Eight grams of tetramethoxysilane (manufactured by Tokyo Chemical Industry Co., Ltd.) and 5 g of a hydrophilic polymer having a silane coupling group at its terminal described below were added to a mixture of 200 g of ethyl alcohol, 10 g of acetylacetone, 10 g of tetraethyl orthotitanate, and 100 g of purified water, followed by stirring at room temperature for 2 hours.

<Synthesis of Hydrophilic Polymer Having a Silane Coupling Group at its Terminal>

In a three necked flask were put 25 g of acrylamide, 3.5 g of 3-mercaptopropyltrimethoxysilane, and 51.3 g of dimethylformamide, and the mixture was heated up to 65° C. in a nitrogen stream. To the mixture was added 0.25 g of 2,2′-azobis(2,4-dimethylvaleronitrile) to initiate reaction. After 6 hour stirring, the reaction system was allowed to cool to room temperature and poured into 1.5 liters of ethyl acetate, whereupon a solid was precipitated. The solid was collected by filtration, thoroughly washed with ethyl acetate, and dried. The resulting product, weighing 21 g, was confirmed to be polymer having weight average molecular weight of 4,000 according to the GPC (polystyrene standard). The polymer had a viscosity of 2.5 cPs in a 5% aqueous solution and a hydrophilic functional group density of 13.4 meq/g.

The release layer of the hydrophilic member structure prepared as above was peeled out and the left adhesive layer was attached to a glass to produce a glass structure.

For the glass, A float plate glass, the most general transparent plate glass, was used.

(Evaluation) The resulting glass structure was evaluated as follows.

(1) Hydrophilic Property

A water droplet contact angle was measured (Measured with DropMaster 500 manufactured by Kyowa Interface Science Co. Ltd.).

(2) Water Resistance

The hydrophilic member (120 cm²) was given 10 to-and-fro rubbings with sponge in water. A film retention (%) was calculated from the change of weight due to the rubbing.

(3) Durability Abrasion Test

The hydrophilic member was given 100 to-and-fro rubbings with nonwoven fabric (BEMCOT manufactured by Asahi Kasei Fibers). The water droplet contact angle was measured before and after the abrasion test. A sample with satisfactory durability has a small contact angle even after being rubbed.

(4) Scratch Test

A sapphire needle of 0.1 nm in diameter was moved over the hydrophilic layer under a load starting from 5 g and increasing by 5 g and weight of occurred scratch was measured (Measured with a scratch tester Type 18S manufactured by Shinto Scientific Co., Ltd.). A sample with satisfactory durability has no visible scratch even under a heavy load.

(5) Storage Stability (Back Side Adhesion)

Fifty 5 cm square glass structures were stacked. The stack was clamped in a vice with an applied torque of 300 kg and left to stand in that state at 45° C. and 75% humidity for one day. After one day standing, a back side adhesion property in the stack was examined.

The results of the evaluation were as follows. The glass structure had a water droplet contact angle of 5° or smaller, proving highly hydrophilic. The film retention was 100%, indicating having no problem. No reduction in hydrophilic property was observed in the abrasion test. No scratches resulted under up to 50 g loading in the scratch test, indicating excellent durability. When the glass structure was stacked one on top of another in the storage stability test, a back side adhesion did not occur, showing excellent storage stability.

### Examples 2 and 3

A hydrophilic layer was produced in the same manner as in Example 1, except for using each of the following catalysts. As a result of evaluation, the resulting hydrophilic member structures were both proved to be equal to the product of Example 1 in hydrophilic property, water resistance, durability, scratch resistance, and storage stability.

### Example 2

### Ethylacetoacetatealuminum Diisopropylate (ALCH, Manufactured by Kawaken Fine Chemical Co., Ltd.)

### Example 3

### Zirconium Chelate Compound

Zirconium chelate compound was prepared by stirring 50 parts of zirconium tetrabutoxide and 20 parts of ethyl acetoacetate in a reactor equipped with a stirrer at room temperature for 1 hour.

### Examples 4 to 9

A hydrophilic layer was produced in the same manner as in Example 1, except for using each of the following hydrophilic polymers. As a result of evaluation, all the hydrophilic member structures obtained were proved to be equal to the product of Example 1 in hydrophilic property, water resistance, durability, scratch resistance, and storage stability.

### Example 4

### Hydrophilic Polymer 9

### Example 5

### Hydrophilic Polymer 13

### Example 6

### Hydrophilic Polymer 15

### Example 7

### Hydrophilic Polymer 24

### Example 8

### Hydrophilic Polymer 36

### Example 9

Synthesis of hydrophilic polymer with a plurality of reactive groups synthesized as follows:

[Synthesis of Hydrophilic Polymer Having a Plurality of Reactive Groups]

(Synthesis of Amide Macromonomer)

In 200 g of ethanol were dissolved 100 g of acrylamide and 10 g of 3-mercaptopropionic acid. The solution was heated to 60° C., and 1 g of 2,2-azobisisobutylnitrile (AIBN) was added thereto, followed by allowing the system to react for 8 hours in a nitrogen atmosphere. After the reaction, the white precipitate formed was collected by filtration and thoroughly washed with methanol to yield 90 g of a carboxyl-terminated prepolymer (acid value: 0.80 meq/g; Mw: 1500). A 50 g of the resulting prepolymer was dissolved in 150 g of dimethyl sulfoxide, and 20 g of glycidyl methacrylate, 1.2 g of N,N-dimethyldodecylamine (catalyst), and 0.2 g of hydroquinone (polymerization inhibitor) were added to the solution. The reaction system was allowed to react at 140° C. in a nitrogen atmosphere for 10 hours. The reaction solution was poured into acetone, and the thus precipitated polymer was collected and washed well to yield 50 g of methacrylate-terminated acrylamide macromonomer (weight average Mw: 1800). Introduction of a polymerizable group to the terminal was confirmed based on the olefin peaks of methacryloyl group at 6.12 ppm and 5.70 ppm by H¹-NMR (D₂O) and a decrease of the acid value.

(Synthesis of Hydrophilic Graft Polymer (1) Using Amide Macromonomer)

In a flask containing 120 g of dimethyl sulfoxide was added dropwise a solution of 8 g of the macromonomer prepared as above, 2 g of γ-methacryloxypropyltrimethoxysilane, and 0.2 g of 2,2-azobis[2-(2-imidazolin-2-yl)propane] (VA061 manufactured by Wako Pure Chemical Industries, Ltd.) in 35 g of dimethyl sulfoxide at 60° C. for 4 hours. After completion of drop addition, heating was continued for an additional 6 hours. The reaction solution was poured into acetone. The precipitated polymer was collected and washed well to produce 14 g of a hydrophilic polymer having a plurality of reactive groups (Mw: 120,000) in a yield of 94%.

### Example 10

A hydrophilic layer was produced in the same manner as in Example 1, except for changing the drying conditions of drying after applying a hydrophilic layer coating composition to 80° C. and 10 minutes. The resulting structure of the hydrophilic member was proved equal to the product of Example 1 in hydrophilic property, water resistance, durability, scratch resistance, and storage stability.

### Comparative Example 1

A glass structure was produced in the same manner as in Example 1, except for attaching the float plate glass described in Example 1 to an left adhesive layer after peeling out a release layer of a commercially available photocatalyst hydrophilic film (Hydrotect Film one year type (clear) manufactured by Toto Ltd.). The photocatalyst hydrophilic film was irradiated with 20 J/cm² ultraviolet light and the UV-irradiated film was equal in hydrophilic property to the product of Example 1 but reduced in hydrophilic property after the abrasion test and suffered from scratches under a load of 5 g in the scratch test, proving inferior in durability.

### Example 11

A support is prepared by forming an adhesive layer and a release layer described below in that order on a back side of a 50 μm thick of polyethylene terephthalate substrate and a surface of the support was subjected to glow discharge treatment to have a hydrophilized surface. A hydrophilic layer coating composition described below was applied to the hydrophilized surface by means of a bar coater and dried in an oven at 100° C. for 10 minutes to form a hydrophilic layer having a dry-coating thickness of 1.0 g/m² and a hydrophilic member was produced. The resulting hydrophilic member had a surface free energy of 87 mN/m, proving to have a very highly hydrophilic surface. The hydrophilic layer had a visible light transmittance of 95% (measured with a spectrophotometer U3000 from Hitachi, Ltd.).

<Adhesive Layer>

A commercially available acrylic emulsion adhesive compound (Emapol R-140, manufactured by Ipposha Oil Industries Co., Ltd.) was applied to the back side of the substrate to have a dry thickness of about 20 μm and dried to form a adhesive layer.

<Release Layer>

To 100 parts by weight of a 50% by weight solution of methyl ethyl ketone of polyglycidyl methacrylate (polystyrene equivalent Mw: 12,000) was added a solution of 150 parts by weight of trimethylolpropane triacrylate (Aronix M-309, manufactured by Tea Gosei Co., Ltd.), 6 parts by weight of a photo radical polymerization initiator (Irgacure 184, manufactured by Ciba Geigy), 6 parts by weight of a photo cationic polymerization initiator (Rhodosil 2074, manufactured by Rhodia), and 10 parts by weight of Megafac 531A (manufactured by Dainippon Ink & Chemicals, Inc.) in 30 parts by weight of methyl isobutyl ketone and mixed while stirring to prepare a coating composition for a release layer.

The coating composition for a release layer was applied on the adhesive layer by extrusion coating to have a thickness of 30 μm, dried, and irradiated with ultraviolet light (1 J/cm²) to form a release layer.

<Coating Composition (1)>

| | |
|---|---|
| 20% by weight aqueous solution of Colloidal silica | 100 g |
| dispersion (Snowtex C) | |
| Sol-gel liquid prepared as follows | 500 g |
| 5% by weight aqueous solution of anionic surface | 30 g |
| active agent described below | |
| Purified water | 450 g |

Anionic Surface Active Agent:

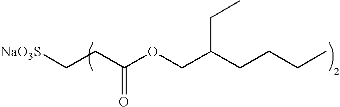

<Sol Gel Liquid>

Eight grams of tetramethoxysilane (manufactured by Tokyo Chemical Industry Co., Ltd.) and 5 g of a hydrophilic polymer having a silane coupling group at its terminal described below were added to a mixture of 200 g of ethyl alcohol, 10 g of acetylacetone, 10 g of tetraethyl orthotitanate, and 100 g of purified water, followed by stirring at room temperature for 2 hours.

<Synthesis of Hydrophilic Polymer Having a Silane Coupling Group at its Terminal>

In a three necked flask were put 25 g of acrylamide, 3.5 g of 3-mercaptopropyltrimethoxysilane, and 51.3 g of dimethylformamide, and the mixture was heated up to 65° C. in a nitrogen stream. To the mixture was added 0.25 g of 2,2′-azobis(2,4-dimethylvaleronitrile) to initiate reaction. After 6 hour stirring, the reaction system was allowed to cool to room temperature and poured into 1.5 liters of ethyl acetate, whereupon a solid was precipitated. The solid was collected by filtration, thoroughly washed with ethyl acetate, and dried. The resulting product, weighing 21 g, was confirmed to be polymer having weight average molecular weight of 4,000 according to the GPC (polystyrene standard). The polymer had a viscosity of 2.5 cPs in a 5% aqueous solution and a hydrophilic functional group density of 13.4 meq/g.

(Evaluation) The resulting hydrophilic member structure was evaluated as follows.

(1) Hydrophilic Property

A water droplet contact angle was measured (Measured with DropMaster 500 manufactured by Kyowa Interface Science Co. Ltd.).

(2) Water Resistance

The hydrophilic member (120 cm²) was given 10 to-and-fro rubbings with sponge in water. A film retention (%) was calculated from the change of weight due to the rubbing.

(3) Durability Abrasion Test

The hydrophilic member was given 100 to-and-fro rubbings with nonwoven fabric (BEMCOT manufactured by Asahi Kasei Fibers). The water droplet contact angle was measured before and after the abrasion test. A sample with satisfactory durability has a small contact angle even after being rubbed.

(4) Scratch Test

A sapphire needle of 0.1 mm in diameter was moved over the hydrophilic layer under a load starting from 5 g and increasing by 5 g and weight of occurred scratch was measured (Measured with a scratch tester Type 18S manufactured by Shinto Scientific Co., Ltd.). A sample with satisfactory durability has no visible scratch even under a heavy load.

(5) Fragility

The hydrophilic member structure was folded and passed through a clearance having maximum bend angle of 5° and a cracking-occurred location in the hydrophilic member structure was measured. A sample with satisfactory fragility has a cracking-occurred location in a short distance from the folded area, which is near the clearance, from viewpoint that the nearer to the clearance is, the tighter the bend angle is.

(6) Storage Stability (Back Side Adhesion) Fifty 5 cm square hydrophilic member structures were stacked. The stack was clamped in a vice with an applied torque of 300 kg and left to stand in that state at 45° C. and 75% humidity for one day. After one day standing, a back side adhesion property in the stack was examined.

The results of the evaluation were as follows. The hydrophilic member structure had a water droplet contact angle of 5° or smaller, proving highly hydrophilic. The film retention was 100%, indicating having no problem. No reduction in hydrophilic property was observed in the abrasion test. No scratches resulted under up to 50 g loading in the scratch test, indicating excellent durability. When the glass structure was stacked one on top of another in the storage stability test, a back side adhesion did not occur, showing excellent storage stability.

### Examples 12 and 13

A hydrophilic layer was produced in the same manner as in Example 11, except for using each of the following catalysts. As a result of evaluation, the resulting hydrophilic member structures were both proved to be equal to the product of Example 11 in hydrophilic property, water resistance, durability, scratch resistance, fragility, and storage stability.

### Example 12

### Ethylacetoacetatealuminum Diisopropylate (ALCH, Manufactured by Kawaken Fine Chemical Co., Ltd.)

### Example 13

### Zirconium Chelate Compound

Zirconium chelate compound was prepared by stirring 50 parts of zirconium tetrabutoxide and 20 parts of ethyl acetoacetate in a reactor equipped with a stirrer at room temperature for 1 hour.

### Examples 14 to 19

A hydrophilic layer was produced in the same manner as in Example 11, except for using each of the following hydrophilic polymers. As a result of evaluation, all the hydrophilic member structures obtained were proved to be equal to the product of Example 11 in hydrophilic property, water resistance, durability, scratch resistance, fragility, and storage stability.

### Example 14

### Hydrophilic Polymer 9

### Example 15

### Hydrophilic Polymer 13

### Example 16

### Hydrophilic Polymer 15

### Example 17

### Hydrophilic Polymer 24

### Example 18

### Hydrophilic Polymer 36

### Example 19

Synthesis of hydrophilic polymer with a plurality of reactive groups synthesized as follows:

[Synthesis of Hydrophilic Polymer Having a Plurality of Reactive Groups]

(Synthesis of Amide Macromonomer)

In 200 g of ethanol were dissolved 100 q of acrylamide and 10 g of 3-mercaptopropionic acid. The solution was heated to 60° C., and 1 g of 2,2-azobisisobutylnitrile (AIBN) was added thereto, followed by allowing the system to react for 8 hours in a nitrogen atmosphere. After the reaction, the white precipitate formed was collected by filtration and thoroughly washed with methanol to yield 90 g of a carboxyl-terminated prepolymer (acid value: 0.80 meq/g; Mw: 1500). A 50 g of the resulting prepolymer was dissolved in 150 g of dimethyl sulfoxide, and 20 g of glycidyl methacrylate, 1.2 g of N,N-dimethyldodecylamine (catalyst), and 0.2 g of hydroquinone (polymerization inhibitor) were added to the solution. The reaction system was allowed to react at 140° C. in a nitrogen atmosphere for 10 hours. The reaction solution was poured into acetone, and the thus precipitated polymer was collected and washed well to yield 50 g of methacrylate-terminated acrylamide macromonomer (weight average Mw: 1800). Introduction of a polymerizable group to the terminal was confirmed based on the olefin peaks of methacryloyl group at 6.12 ppm and 5.70 ppm by H¹-NMR (D₂O) and a decrease of the acid value.

(Synthesis of Hydrophilic Graft Polymer (1) Using Amide Macromonomer)

In a flask containing 120 g of dimethyl sulfoxide was added dropwise a solution of 8 g of the macromonomer prepared as above, 2 g of γ-methacryloxypropyltrimethoxysilane, and 0.2 g of 2,2-azobis[2-(2-imidazolin-2-yl)propane] (VA061 manufactured by Wako Pure Chemical Industries, Ltd.) in 35 g of dimethyl sulfoxide at 60° C. for 4 hours. After completion of drop addition, heating was continued for an additional 6 hours. The reaction solution was poured into acetone. The precipitated polymer was collected and washed well to produce 14 g of a hydrophilic polymer having a plurality of reactive groups (Mw: 120,000) in a yield of 94%.

### Example 20

A hydrophilic layer was produced in the same manner as in Example 11, except for changing the drying conditions of drying after applying a hydrophilic layer coating composition to 80° C. and 10 minutes. The resulting structure of the hydrophilic member was proved equal to the product of Example 11 in hydrophilic property, water resistance, durability, scratch resistance, fragility, and storage stability.

### Comparative Example 2

A commercially available photocatalyst hydrophilic film (Hydrotect Film one year type (clear) manufactured by Toto Ltd.) was irradiated with 20 J/cm² ultraviolet light and the UV-irradiated film was equal in hydrophilic property to the product of Example 11 but reduced in hydrophilic property after the abrasion test and suffered from scratches under a load of 5 g in the scratch test, proving inferior in durability.

This application is based on Japanese Patent application JP 2005-331654, filed Nov. 16, 2005, and Japanese Patent application JP 2005-331655, filed Nov. 16, 2005, the entire contents of which are hereby incorporated by reference, the same as if set forth at length.

1. A structure comprising:
an adhesive layer;
a plastic substrate; and
a hydrophilic coating film, provided in this order,
wherein the hydrophilic coating film includes a cross-linked structure produced by hydrolysis and polycondensation with an aqueous solution containing (a) a hydrophilic polymer and (b) an alkoxide of a metal selected from the group consisting of Si, Ti, Zr, and Al.

2. The structure according to claim 1, wherein the structure further comprises a glass layer so that the glass layer, the adhesive layer, the plastic substrate, and the hydrophilic coating film are provided in this order.

3. The structure according to claim 1, wherein the structure further comprises an exfoliatable release layer so that the release layer, the adhesive layer, the plastic substrate, and the hydrophilic coating film are in this order.

4. The structure according to claim 1, wherein the aqueous solution further contains a metal complex catalyst.

5. The structure according to claim 1, wherein the hydrophilic coating film contains a colloidal silica.

6. The structure according to claim 1, wherein a surface of the plastic substrate is hydrophilized before the plastic substrate is coated with the aqueous solution.

7. The structure according to claim 1, wherein the hydrophilic polymer is represented by the following formula (I) or (II): 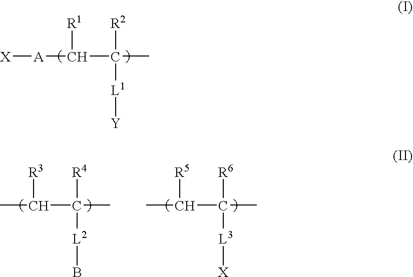
wherein R¹, R², R³, R⁴, R⁵, and R⁶ each independently represent a hydrogen atom or a hydrocarbon group having from 1 to 8 carbon atoms; X represents a reactive group; A, L¹, L², and L³ each independently represent a single bond or a linking group; Y represents —NHCOR⁷, —CONH₂, —CON(R⁷)₂, —COR⁷, —OH, —CO₂M, —SO₃M, —PO₃M, —OPO₃M or —N(R⁷)₃Z¹, in which R⁷ represents an alkyl group having from 1 to 18 carbon atoms, an aryl group having from 1 to 18 carbon atoms or an aralkyl group having from 1 to 18 carbon atoms, M represents a hydrogen atom, an alkali metal, an alkaline earth metal or an onium group, and Z¹ represents a halide ion; and B represents a structure represented by the following formula (III): 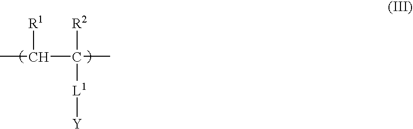
wherein R¹ and R² each independently represent a hydrogen atom or a hydrocarbon group having from 1 to 8 carbon atoms, L¹ represents a single bond or a linking group, and Y represents —NHCOR⁷, —CONH₂, —CON(R⁷)₂, —COR⁷, —OH, —CO₂M, —SO₃M, —PO₃M, —OPO₃M or —N(R⁷)₃Z¹, in which R⁷ represents an alkyl group having from 1 to 18 carbon atoms, an aryl group having from 1 to 18 carbon atoms or an aralkyl group having from 1 to 18 carbon atoms, M represents a hydrogen atom, an alkali metal, an alkaline earth metal or an onium group, and Z¹ represents a halide ion.

8. The structure according to claim 1, wherein the hydrophilic coating film has a surface free energy of from 70 to 95 mN/m.

9. The structure according to claim 1, wherein the hydrophilic polymer has a hydrophilic group density of from 1 to 30 meq/g.

10. The structure according to claim 1, wherein the hydrophilic polymer has a viscosity of from 0.1 to 100 cPs in a 5% aqueous solution.

11. The structure according to claim 1, wherein the hydrophilic coating film has a light transmittance of from 70 to 100%.

12. A process for producing a structure including an adhesive layer, a plastic substrate, and a hydrophilic coating film, provided in this order,
wherein the process comprises:
coating the substrate with an aqueous solution containing (a) a hydrophilic polymer, (b) an alkoxide of a metal selected from the group consisting of Si, Ti, Zr, and Al, and (c) a metal complex catalyst; and
heat-drying the solution applied to the substrate, to form the hydrophilic coating film which includes a cross-linked structure.

13. The process according to claim 12, in which a glass layer is provided so that the glass layer, the adhesive layer, the plastic substrate, and the hydrophilic coating film are provided in this order.

14. The process according to claim 12, in which an exfoliatable release layer is provided, so that the release layer, the adhesive layer, the plastic substrate, and the hydrophilic coating film are provided in this order.
